(19) United States
(12) Patent Application Publication
(10) Pub. No.: US 2007/0092072 A1
(43) Pub. Date: Apr. 26, 2007

(54) Efficient phone and e-mail resolution with contact data

(75) Inventor: Andrew W. Jacobs, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/239,822

(22) Filed: Sep. 30, 2005

(51) Int. Cl. H04M 15/06; H04M 1/56

(52) U.S. Cl. 379/142.06

(57) ABSTRACT

The sender of a telephone call or an e-mail message is represented by an incoming contact identifier, such as the originating phone number or e-mail address, respectively. The recipient of the telephone call or e-mail message can identify the contact corresponding to the incoming identifier by matching the identifier with an entry in a data store. The data store comprises of an alphabetized index of contact/translated contact identifier pairs for efficient lookup. The incoming identifier is translated in order to match an entry in the index. The position in the index of the translated identifier is determined and if a sufficient match is found, the corresponding contact is indicated. Otherwise, the closest matches are noted or a message indicating that no conclusive match was found is communicated.

### BACKGROUND

The use of telephone and e-mail systems to communicate is more popular now than ever. With the proliferation of communications devices, the need for fast and accurate contact identification is necessary. Contacts are represented by an identifier, such as a telephone number in the situation of a telephone call and an e-mail address in the situation of an e-mail message. Although electronic systems can easily (and preferably) represent contacts using a contact identifier, people do not naturally refer to others by their phone numbers or e-mail addresses. Instead, people primarily recognize others by their names or nicknames and prefer that such name or nickname is incorporated into the user interface. For instance, a person would recognize a call from his mom based on the name “Mom,” while a system would recognize that call based on the phone number, and the name “Mom” is essentially ignored from the perspective of the system.

When a person receives a phone call, the display usually indicates at least the originating phone number. This is the phone number that a device would recognize in order to route the call if one were to dial that number. If this phone number was saved in the receiver's list of contacts, other specific information corresponding to the originating phone number may appear. For example, the phone might display the name of the caller or a nickname of the caller. It might pose a problem if the system incorrectly identified the wrong contact or failed to identify a contact that was in fact stored in the receiver's list of contacts. In addition, a slow identification system could delay notification for the phone call, causing the caller to hang up, be sent to voicemail, or wait an unnecessarily long time. A similar situation occurs with the use of e-mail applications as well, where a person would most likely prefer to interact with the contact name (e.g., Jane Doe) rather than the e-mail address (e.g., tennispro3@hotmail.com).

Such contact information may be stored in a mobile phone or computer application. Not only can the device use this information to identify incoming calls, but a user may use this information to call contacts in their directory. Since many people use electronic communications for all purposes, social and business, and typically depend on their use at least numerous times throughout the day, it is important that these systems are reliable.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts of the subject matter in a simplified form as a prelude to the more detailed description that is presented later.

The claimed subject matter relates generally to contact identification, and more particularly to systems and methods for matching incoming contact identifiers with stored contacts. An alphabetized index of translated contact identifiers and corresponding contacts is maintained in a data store. The contact identifiers are translated according to type. If the contact identifier is a phone number, the translated phone number appears as the digits in reverse order. For example, the phone number 4082345678 would appear as 8765432804. If the contact identifier is an e-mail address, the translated e-mail address appears as the portion before the “@” delimiter (i.e., the user identification) in plain order and the portion after the “@” delimiter (i.e., the domain name) in reverse order. For example, the e-mail address jdoe@mit.edu would appear as jdoe@ude.tim. The index can be updated through various instruments, including: the contact lookup component, the user, or an external component (e.g., an Internet or intranet search).

A contact lookup component receives an incoming contact identifier, translates the contact identifier to match the format of the entries in the index, locates the position of the contact identifier in the index, determines a corresponding contact match, and returns or displays the contact name. When the contact lookup component locates the position of the contact identifier in the index and discovers that an entry already exists, an exact match has been found. When the contact lookup component discovers that an entry does not exist in that position, the two adjacent entries are evaluated by an artificial intelligence component to determine the best contact match. Through this, a less efficient and more time consuming exact and exhaustive search is not required.

For instance, the evaluation can proceed by comparing the leading strings of the contact identifiers. In one example, an incoming contact identifier jdoe@mit.edu (reformatted to jdoe@ude.tim), could be compared to the two closest entries: jdoe@stanford.edu (reformatted to jdoe@ude.drofnats) and jdoe@ai.mit.edu (reformatted to jdoe@ude.tim.ia). The artificial intelligence component could determine that by comparing the leading string of jdoe@ude.tim with the leading strings of jdoe@ude.drofnats and jdoe@ude.tim.ia, jdoe@ude.tim has more characters in common with jdoe@ude.tim.ia (i.e., jdoe@ude.tim) than jdoe@ude.drofnets (i.e., jdoe@ude.). The evaluation would then conclude that jdoe@ude.tim.ia is a sufficient and best match and return a match of the contact corresponding to jdoe@ai.mit.edu for the incoming contact identifier jdoe@mit.edu. Alternatively, if the artificial intelligence component determines that neither match is sufficiently accurate, the contact lookup component can return no match and/or provide the user with information resulting from the artificial intelligence analysis. The user may choose to record or disregard this information for future use.

The claimed subject matter may be implemented on numerous user interfaces, such as PDAs, mobile phones, landline phones, laptop computers, and desktop computers. The data store may be reserved for one user (e.g., personal data in a mobile phone) or shared among many users (e.g., shared data within a company).

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter may be employed, and such matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a block diagram of a contact resolution system in accordance with an aspect of an embodiment.

FIG. 2 is a block diagram of a contact lookup component in accordance with an aspect of an embodiment.

FIG. 3 is a flow diagram of a method of facilitating contact resolution in accordance with an aspect of an embodiment.

FIG. 4 is another flow diagram of a method of facilitating contact resolution in accordance with an aspect of an embodiment.

FIG. 5 is another flow diagram of a method of facilitating contact resolution in accordance with an aspect of an embodiment.

FIG. 6 is yet another flow diagram of a method of facilitating contact resolution in accordance with an aspect of an embodiment.

FIG. 7 illustrates a user interface in which an aspect of an embodiment can function.

FIG. 8 illustrates another user interface in which an aspect of an embodiment can function.

FIG. 9 illustrates an arrangement of the index in accordance with an aspect of an embodiment.

FIG. 10 illustrates another arrangement of the index in accordance with an aspect of an embodiment.

FIG. 11 is a schematic block diagram illustrating a suitable operating environment.

FIG. 12 is a schematic block diagram of a sample-computing environment

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the embodiments.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Further, as utilized herein, the term “contact” refers to a label, name, or nickname that indicates a person or object in human terms (e.g., John Doe). A “contact identifier” represents the contact in machine readable terms, such as an address (e.g., jdoe@mit.edu) or a phone number (e.g., 4082345678).

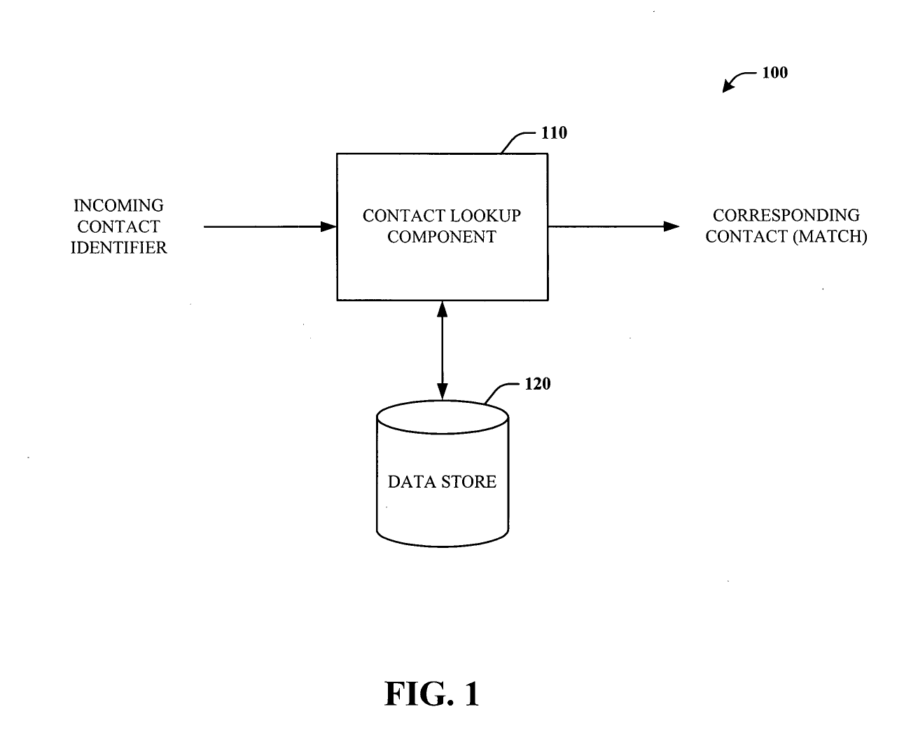

In FIG. 1, a block diagram of a contact resolution system 100 is illustrated. The contact resolution system 100 comprises a contact lookup component 110 that interfaces with a data store 120. The contact lookup component 110 receives an incoming contact identifier, references a data store 120, and outputs a contact match that corresponds to the incoming contact identifier. The output may be communicated through a visual display and/or an audio notification. The data store 120 contains an alphabetical index of translated contact identifiers and corresponding contacts, organized by order of the translated contact identifiers.

In one example, the contact lookup component 110 receives an incoming contact identifier as a phone number, 4082345678. Using the data store 120, the contact lookup component 110 recognizes this phone number as belonging to John Doe, and outputs a corresponding contact of John Doe by displaying the name on a screen and outputting an audio signal pre-assigned by a user. This audio can be a specific preference unique to the contact (e.g., John Doe).

In another example, the contact lookup component 110 receives an incoming contact identifier as an e-mail address, jdoe@mit.edu. Referencing the data store 120, the contact lookup component 110 discovers that no matching contact/contact identifier pairs exist, but determines that jdoe@ai.mit.edu likely refers to the same contact and outputs John Doe. In this case, the contact lookup component selects a notification method based on the current situation and decides to indicate a visual output, rather than an audio output, because it is midnight. Such preference is a general setting applied to all incoming messages from all contacts.

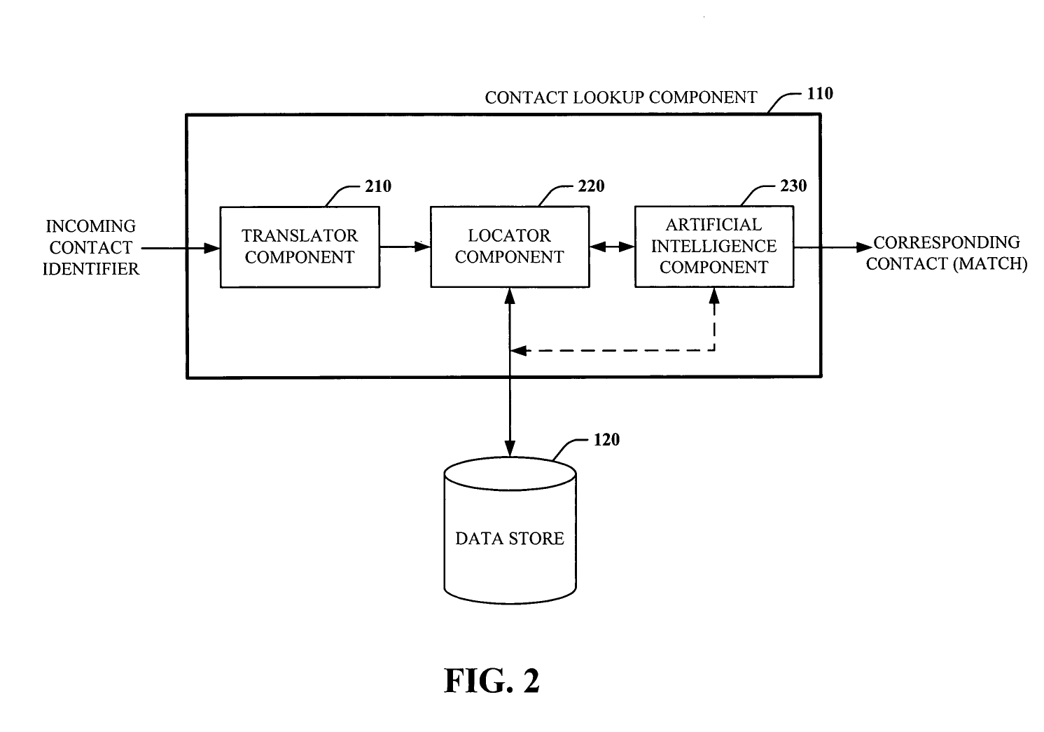

Referring to FIG. 2, a block diagram of the contact lookup component 110, which facilitates locating a contact by way of reverse indexing, is illustrated. The contact lookup component 110 comprises a translator component 210, a locator component 220, and an artificial intelligence component 230. The contact lookup component 110 receives an incoming contact identifier and outputs a matching contact.

The translator component 210 transforms the contact identifier to match the format of the entries in the data store. If the contact identifier is a phone number, the translator component 210 reverses all digits of the phone number. For instance, incoming phone number 4082345678 is translated to appear as 8765432804. If the contact identifier is an e-mail address, the translator component 210 reverses only those characters (constituting the domain name) that appear after the “@” delimiter and leaves the remaining order (constituting the user identification) the same. For instance, incoming e-mail address jdoe@mit.edu is translated to appear as jdoe@ude.tim.

The locator component 220 receives the translated contact identifier from the translator component 210 and proposes possible contact matches. First, the locator component identifies the position in the alphabetized index in the data store 120 where the translated contact identifier would appear. If an entry already exists in that position, the locator component 220 has found an exact match and outputs that match. If an entry does not exist in that position, the locator component 220 outputs the entry immediately before and immediately after the position as prospective matches.

The artificial intelligence component 230 receives the prospective matches from the locator component 220 and decides which match is a sufficient and best match. When the locator component 220 has not found an exact match, the artificial intelligence component 230 evaluates the two nearest matches and employs a leading string comparison. For instance, a translated incoming contact identifier of jdoe@ude.tim compared to jdoe@ude.drofnats and jdoe@ude.tim.ia would return a match of jdoe@ude.tim.ia because its leading string (i.e., jdoe@ude.tim) is a closer match than the leading string of jdoe@ude.drofnats (i.e., jdoe@ude.). In addition, the artificial intelligence component may also access the data store 120 for further information to perform its analysis. In other words, given particular data and context, the artificial intelligence component 230 (as illustrated by the above example) can perform inferences in connection with determining an appropriate contact identity to provide to a user. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

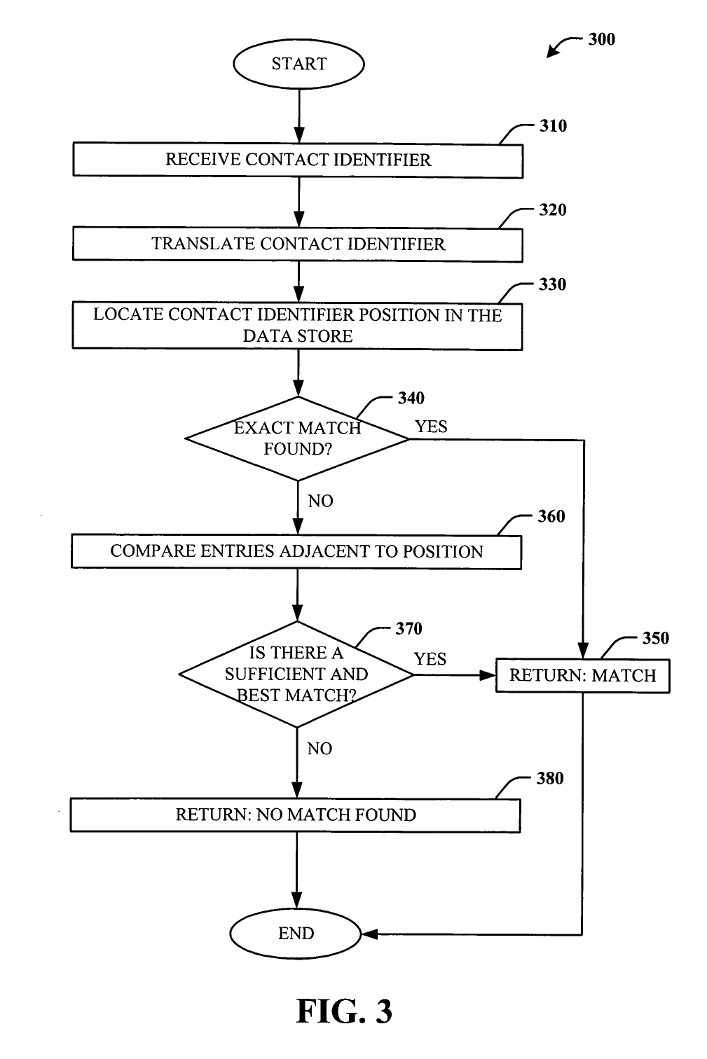

In view of the exemplary systems shown and described above, methodologies that may be implemented in accordance with the claimed subject matter will be better appreciated with reference to the flow charts of FIGS. 3-6. While, for purposes of simplicity of explanation, the methodologies are shown and described as a series of acts, it is to be understood and appreciated that the methodologies are not limited by the order of the acts, as some acts may, in accordance with the claimed subject matter, occur in different orders and/or concurrently with other acts from that shown and described herein. Moreover, not all illustrated acts may be required to implement the methodologies.

Furthermore, acts described in connection with the methodologies may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 3, a flow diagram of a method 300 for facilitating contact resolution. The method 300 starts by receiving a contact identifier at 310, such as a phone number from an incoming phone call or an e-mail address from an incoming e-mail message. Alternatively, the phone number or e-mail address can be entered directly by the user of a search engine and database configuration to identify the corresponding contact. Next, the contact identifier is translated at 320 by reversing the digits of the phone number or reversing the characters after the delimiter (e.g., the “@” character) of the e-mail address. For instance, a data store comprises an alphabetical index of translated contact identifiers and corresponding contacts, as well as contact-specific preferences. At 330, the position of the translated incoming contact identifier in the index is located. The existence of an entry in that position indicates whether an exact match has been found at 340. If an exact match has been found at 340, that match is returned at 350. If an exact match has not been found at 340, the incoming contact identifier is compared to the entries adjacent to the position at 360. At 370, the leading strings of the entries are compared to the leading string of the incoming contact identifier and it is determined whether one of those entries is a sufficient and best match of the incoming contact identifier. If one of those entries is determined to be a match, that match is returned at 350. Otherwise, a message noting that no match has been found is returned at 380. Alternatively, the method 300 may return the next closest matches (e.g., the entry above and below the target position) indicating that no conclusive match has been found.

Additional analysis may be undertaken at 360 to determine whether a match has been found. A matching mechanism can utilize other types of comparison other than a leading string comparison, such as a partial subset evaluation, a message content evaluation, and a message context evaluation. A partial subset evaluation compares any subset of characters in no particular order. A message content evaluation analyzes the message in conjunction with the contact information to identify a match. For example, if a contact has more than one match option, evaluating the content of the corresponding message may help identify which of the options would be a closer match. A message that involves meetings or conferences may help indicate that the sender is a business contact rather than a social contact. Likewise, a message where the “to” field includes other identified social contacts is most likely from a sender that is also a social contact. A message context evaluation takes into account the circumstances in which the message is sent. For instance, where a contact has more than one potential match, a message sent on a Sunday would likely indicate that the sender is a social contact. In another example, the time of day a message is received can help identify a contact match. For two potential contact matches A and B, if contact A usually sends messages in the morning and contact B usually sends messages in the evening, a message received in the morning can indicate that the message was sent by contact A.

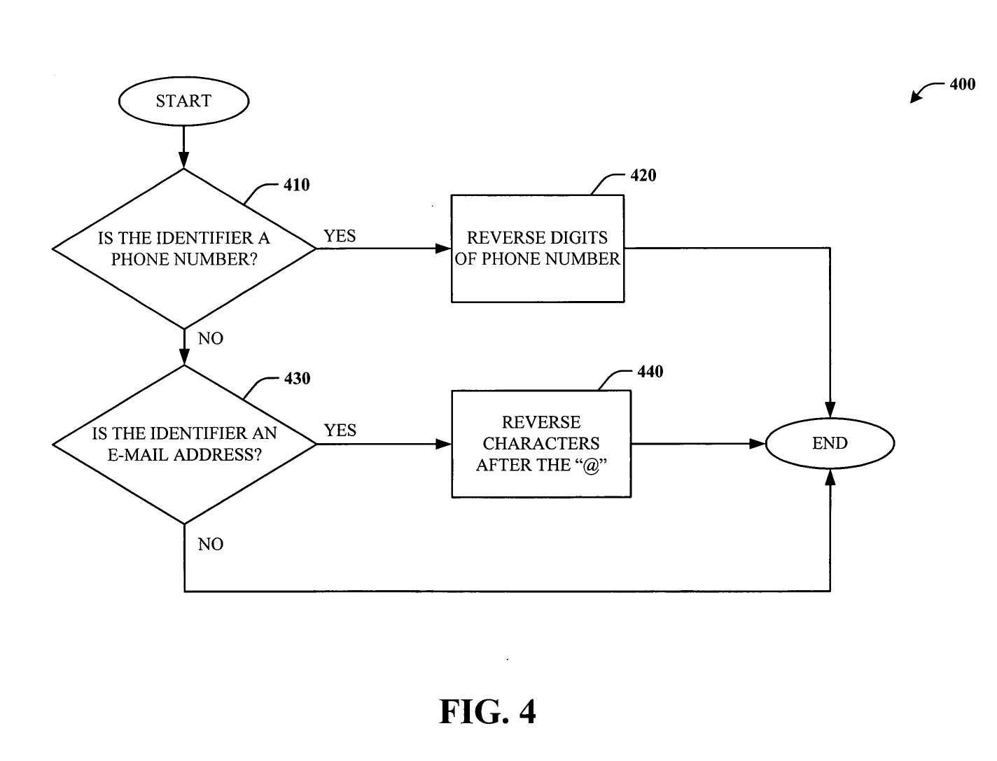

FIG. 4 illustrates a method 400 for facilitating contact resolution. In particular, the method 400 demonstrates how a contact identifier is translated. The method 400 starts by determining whether the identifier is a phone number at 410. If the identifier is a phone number, the digits of the phone number are reversed at 420 (e.g., incoming identifier 4082345678 is translated to appear as 8765432804). If the identifier is not a phone number, the method 400 determines whether the identifier is an e-mail address at 430. If the identifier is an e-mail address, the characters after the “@” character are reversed at 440 (e.g., jdoe@mit.edu is translated to appear as jdoe@ude.tim).

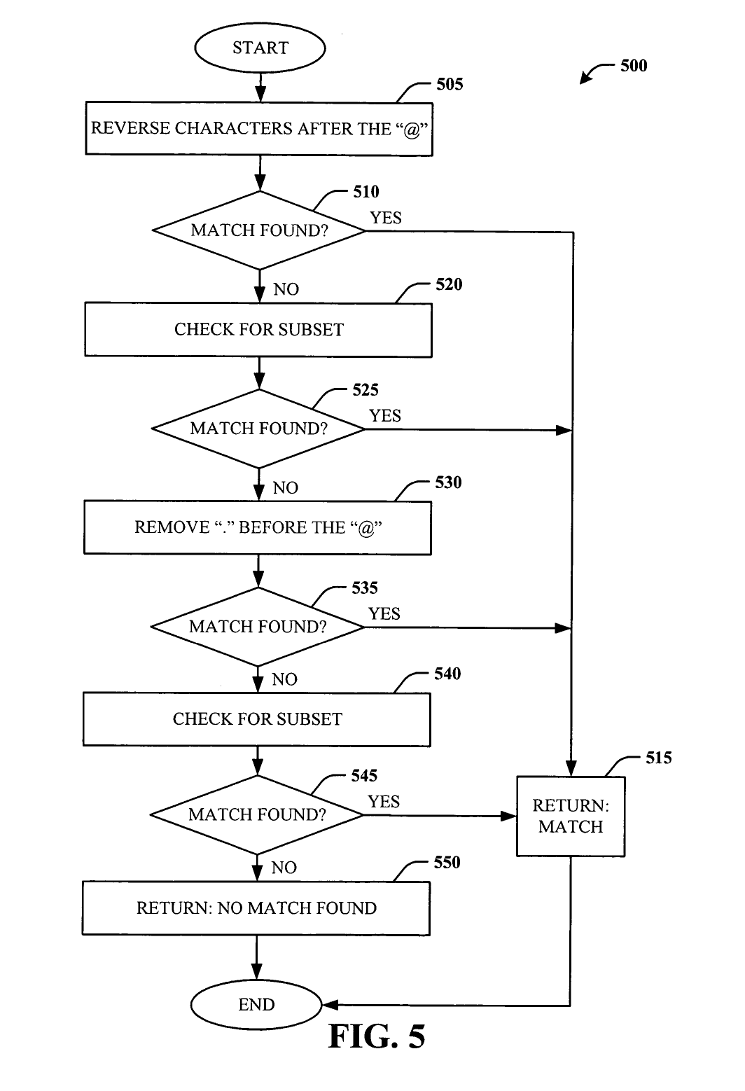

FIG. 5 illustrates another method 500 for facilitating contact resolution. The method 500 further depicts how a match is identified for an e-mail address. At 505, the characters after the “@” delimiter are reversed. If a sufficient match is found at 510, the corresponding contact is identified at 515; otherwise the contact identifier is processed by a method other than the index lookup to find a match. The method 500 proceeds to check for subset matches of the contact identifier at 520. For example, an incoming identifier of johndoe@ai.mit.edu might correspond to the stored identifier, johnndoe@mit.edu. If a match is found at 525, the corresponding contact is returned at 515. If a sufficient match has not been determined at 525, the translation proceeds by removing the “.” character before the “@” delimiter at 530. If a sufficient match is determined at 535, the corresponding contact is identified at 515. This translation, for example, would match an incoming e-mail address of john.doe@mit.edu (translated as johndoe@ude.tim) with the corresponding contact of e-mail address of johndoe@mit.edu (also translated as johndoe@ude.tim). Other characters, such as “-” and “_”, may be removed as well to further the translation. If a sufficient match has still not been determined at 535, the translation performs a subset check once again at 540. If a match is found at 545, the corresponding contact is returned at 515. If a match is not found at 545, the method 500 indicates that no match has been found at 550.

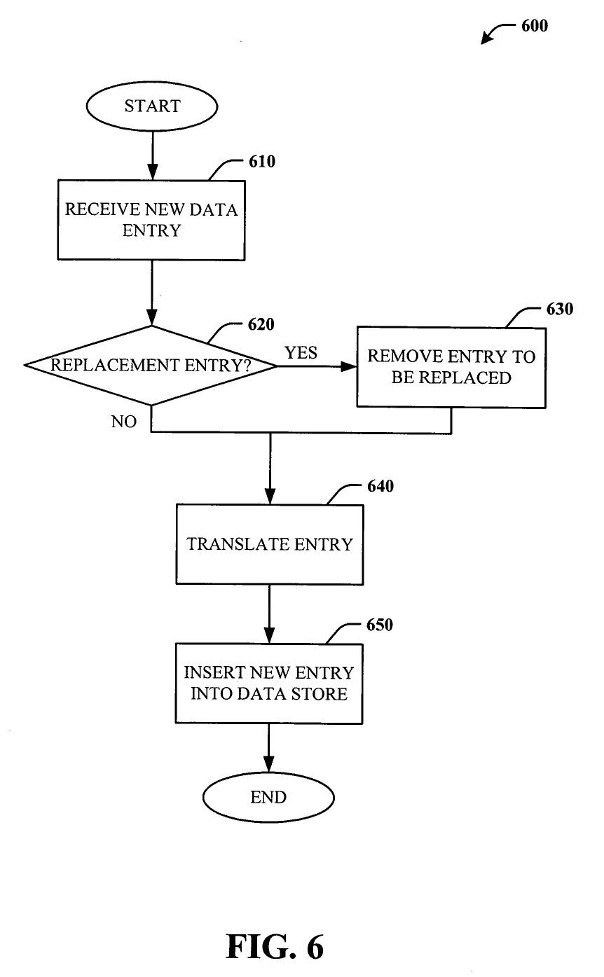

FIG. 6 illustrates a method 600 for updating the contact database. This method 600 describes how an index in the data store is updated. The current translated identifiers in the data store index are arranged in alphabetical order to enable efficient lookup. First, a new data entry is received at 610. The entry may be initiated by the user, another contact of the user, by an external process (e.g., a synchronization process), or by the index itself. The updates can be done manually on command or automatically as programmed. The information can be obtained directly from a user or from an external source (e.g., the Internet or intranet). At 620, the method 600 determines whether the incoming entry is a contact identifier that adds a new entry to the index or replaces a current entry in the index. If the incoming entry is a replacement entry, the existing entry to be replaced is removed from the index at 630 before the incoming entry is translated at 640. If the incoming entry is an addition to the index, the method 600 directly proceeds to translate that entry at 640. The translation is performed so that the format of the incoming entry is consistent with the format of the existing entries in the index. In the case of a phone number, the digits of the phone number are reversed. In the case of an e-mail address, only the characters after the delimiter (i.e., the “@” character) are reversed. After the incoming contact identifier is translated, that entry is properly inserted into the alphabetized data store index at 650.

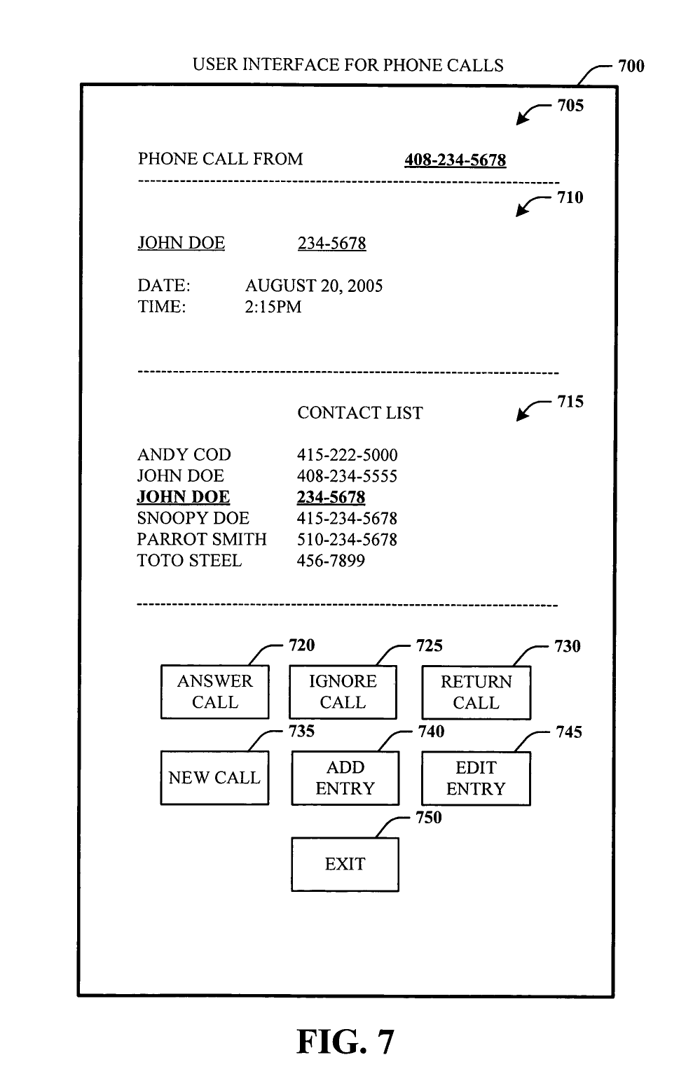

Continuing to FIG. 7, a user interface that can be employed in connection with one or more aspects provided herein. A user interface for phone calls 700 includes a display area for the incoming contact identifier 705, a display area for the contact match and call information 710, a display area for the proximate entries in the contact list 715, and command buttons 720, 725, 730, 735, 740, 745, and 750.

The display area for the incoming contact identifier 705 indicates the actual incoming phone number of the call (i.e., 4082345678). Although the displayed phone number can include hyphens for user readability purposes, the phone number may be displayed in other formats (e.g., 408234 5678, (408)234-5678, or 4082345678). The display area for contact match and call information 710 indicates the contact name and corresponding phone number concluded as a match of the incoming contact identifier, as well as the date and time of the incoming call. In this example, incoming phone number 408-234-5678 was received on Aug. 20, 2005 at 2:15 PM and best matched the stored contact identifier 234-5678 belonging to the contact John Doe. The display area for the proximate entries in the contact list 715 shows the entries around the target position that pose a possible match. For instance, the position of the incoming identifier would have been situated between the John Doe and Snoopy Doe entries. A few entries above the position and a few entries below the position (as arranged in the index) are displayed, and the actual concluded match is highlighted (i.e., John Doe). However, taking into account physical space considerations, the user interface 700 may omit any or all portions of display areas 710 and 715 as preferred. The implementation on a laptop or computer screen may allow all portions to be displayed, while the implementation on a mobile phone or PDA may require a condensed display.

The command buttons 720, 725, 730, 735, 740, 745, and 750 represent actions a user can select in response to the current phone call. The user can choose to answer the call 720, ignore the call 725, return the call 730, place a new call 735, add an entry to the contact list 740, edit an entry in the contact list 745, or exit the current display 750. The command buttons can be expanded or limited in consideration of physical space constraints and convenience preferences.

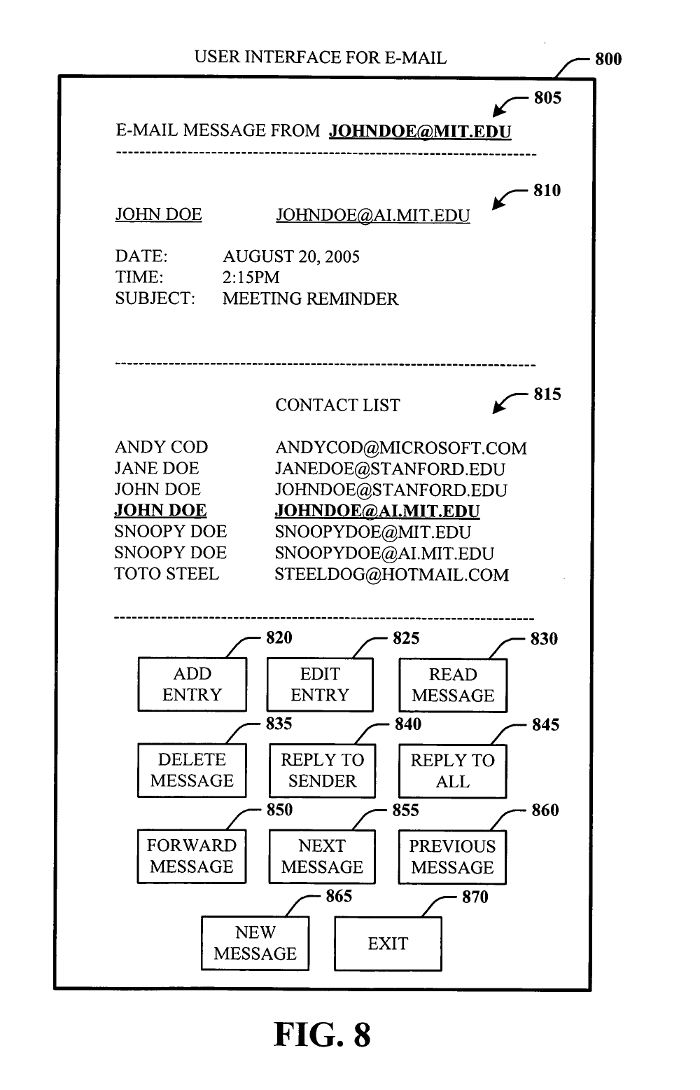

As shown in FIG. 8, another user interface in which an aspect of an embodiment can function is illustrated. The user interface for e-mail 800 comprises a display area for the incoming contact identifier 805, a display area for the contact match and message information 810, a display area for the proximate entries in the contact list 815, and command buttons 820, 825, 830, 835, 840, 845, 850, 855, 860, 865, and 870. Various adjustments can be made to suit a particular user's needs and desires.

The display area for the incoming contact identifier 805 shows the actual incoming e-mail address for the message (i.e.,johndoe@mit.edu). The display area for contact match and message information 810 indicates the contact name and corresponding e-mail address sufficiently matching the incoming identifier, as well as the date and time of the message. For example, an incoming message from e-mail address johndoe@mit.edu was received on Aug. 20, 2005 at 2:15 PM and best matched the stored contact identifier johndoe@ai.mit.edu belonging to the contact John Doe. The display area for the proximate entries in the contact list 815 displays the entries surrounding the target position. In this example, the position of the incoming identifier would have been situated after the John Doe “stanford.edu” entry and before the John Doe “ai.mit.edu” entry. Entries above and below this position, as arranged in the index, are displayed, and the actual match determined by the artificial intelligence component is highlighted (i.e., John Doe). Again, if there are physical space constraints or preferences, the user interface 800 may omit any or all portions of display areas 810 and 815 as preferred. Therefore, the implementation may display all portions of the user interface on a laptop or computer screen, but leave out some parts on a mobile phone or PDA.

The command buttons 820, 825, 830, 835, 840, 845, 850, 855, 860, 865, and 870 indicate possible actions a user can select with respect to the current e-mail message. The user can choose to add an entry to the contact list 820, edit an entry in the contact list 825, read the message 830, delete the message 835, reply to the sender 840, reply to the sender and all recipients of the message 845, forward the message 850, display information from the next message 855, display information from the previous message 860, compose a new message 865, or exit the current display 870.

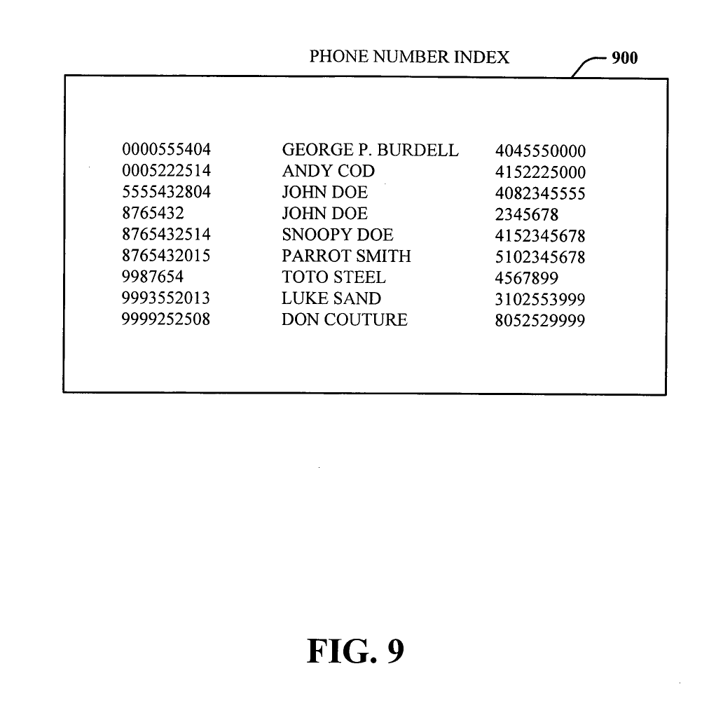

FIG. 9 refers to an exemplary arrangement of an index 900. Note that all or part of the index 900 may be limited to access by one or more users. Alternatively, all or part of the index 900 may be shared among all users in a network, such as the Internet or a company-wide intranet. The index 900 may be duplicated for each user or centrally located for all users. The index 900 may also include a pointer to another index. The phone number index 900 is arranged alphabetically by translated phone number and includes the corresponding contact name and phone number as originally formatted. As noted above, the phone numbers are translated by reversing the digits. For lookup purposes, the translated phone numbers are referenced and once an entry is selected, the corresponding information is sent. Although this illustration depicts the contact name and originally formatted phone number as the corresponding information, other information may be included as well. In particular, specific preferences may be saved, such as an automatic command (e.g., immediately forward all incoming calls from a certain contact to voicemail) or a special audio notification. Likewise, the originally formatted phone number may be omitted. In this case, the stored translated phone numbers would have to be reverse formatted each time an entry is displayed on the user interface.

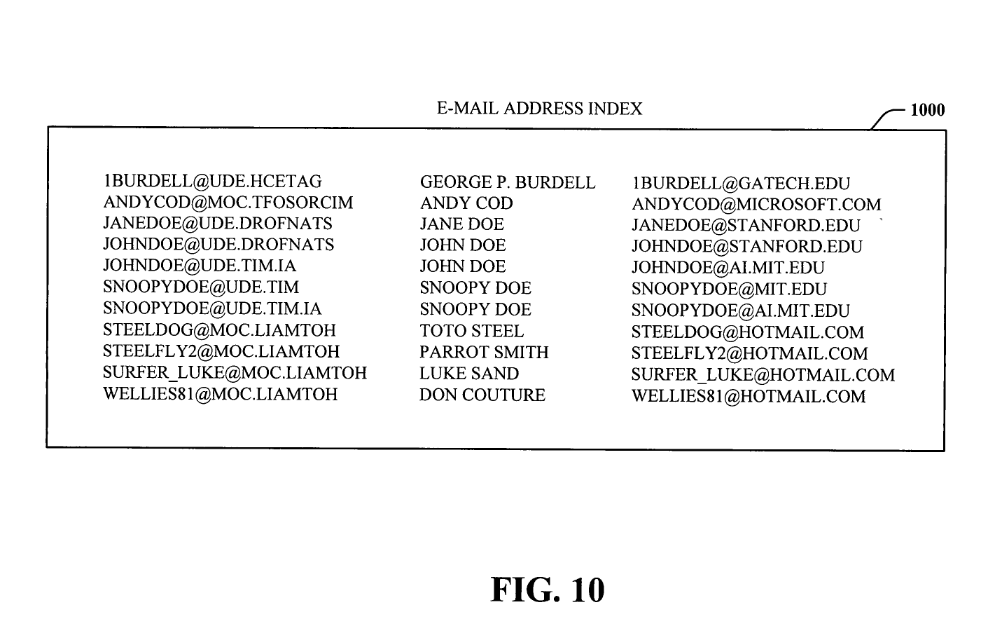

As illustrated, FIG. 10 illustrates a disparate arrangement of an index 1000. Again, one or more users may have secure access to the index 1000, or all users connected to a network (e.g., the Internet or intranet) may have access to the index 1000. If more than one user can access an index 1000, he may extract a copy of the index 1000 or directly reference the index 1000 at its central location. The index 1000 can include a pointer to an index at another location. The e-mail address index 1000 is arranged alphabetically by translated e-mail address and is paired with the corresponding contact name and originally constructed e-mail address. The e-mail addresses are translated by maintaining the portion before the delimiter (i.e., the “@” character) in plain order and reversing the characters after the delimiter (i.e., the “@” character). To perform a lookup in the index, the position of the incoming identifier in the index is determined. The display includes at least the contact name and originally formatted e-mail address corresponding to the translated contact identifier. In conjunction with that information, specific settings relating to notification methods or further actions can be triggered for a particular entry. However, the index 1000 may leave out the e-mail address as originally formatted, such that before information is displayed on the user interface, the reverse formatting of the translated e-mail address would be needed.

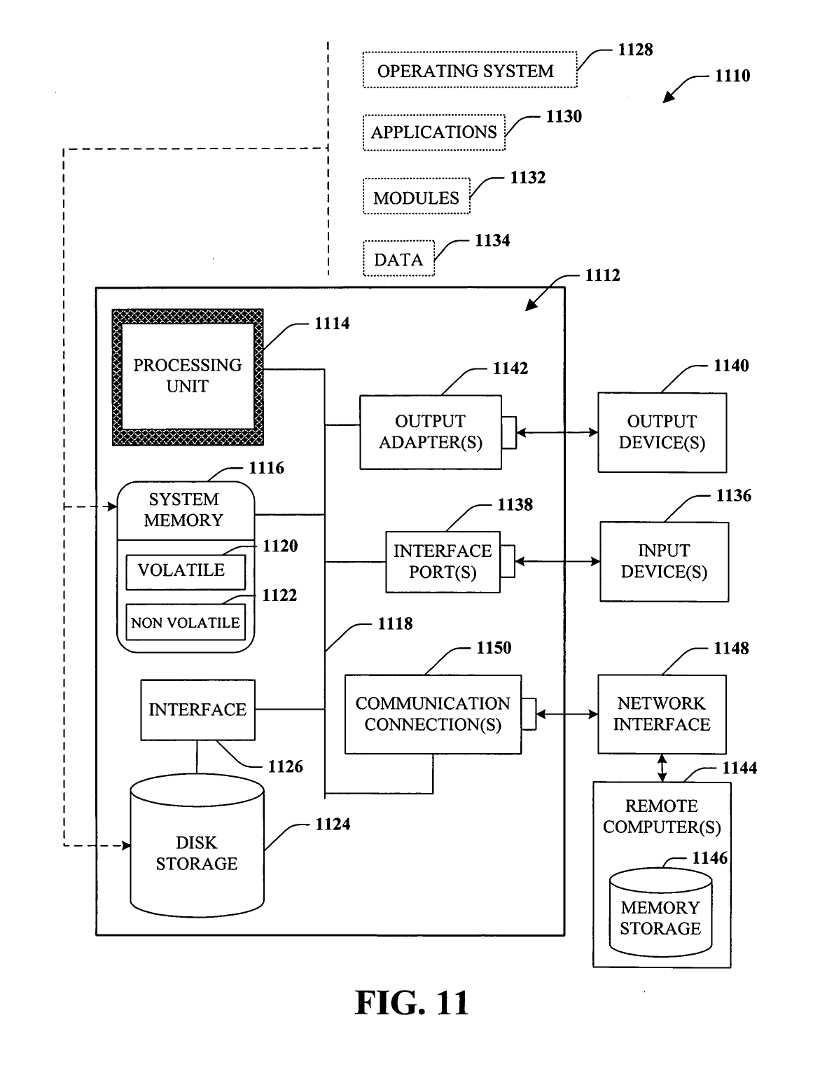

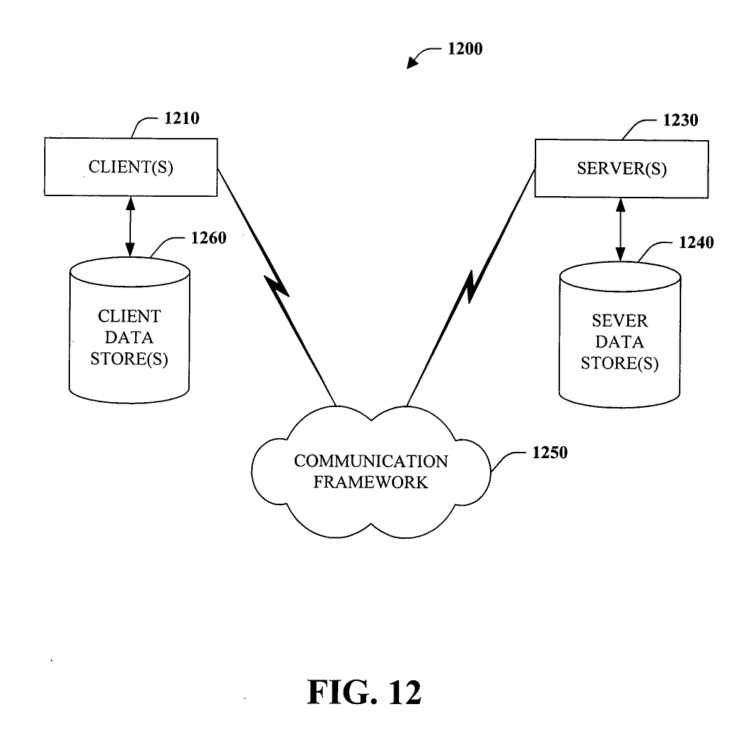

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the present invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112 and to output information from computer 1112 to an output device 1140. Output adapter 1142 is provided to illustrate that there are some output devices 1140 like displays (e.g., flat panel and CRT), speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection(s) 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems, power modems and DSL modems, ISDN adapters, and Ethernet cards or components.

FIG. 12 is a schematic block diagram of a sample-computing environment 1200 with which the present invention can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the present invention, for example. One possible communication between a client 1210 and a server 1230 may be in the form of a data packet adapted to be transmitted between two or more computer processes. The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

It is to be appreciated that the systems and/or methods of the embodiments can be facilitated with computer components and non-computer related components alike. Further, those skilled in the art will recognize that the systems and/or methods of the embodiments are employable in a vast array of electronic related technologies, including, but not limited to, computers, servers, phones, and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates matching a contact identifier with a contact, comprising the following computer-executable components:
a data store that includes an index of translated contact identifiers and corresponding contacts; and
a contact lookup component that receives and translates a contact identifier and returns a corresponding contact from the index.

2. The system of claim 1, further comprising a locator component that identifies the corresponding contact from the data store based at least in part on the translated contact identifier and incorporates notification preferences based at least in part on a general setting and a specific setting.

3. The system of claim 2, further comprising a translator component that translates the contact identifier into a format utilized by the locator component.

4. The system of claim 3, further comprising an artificial intelligence component that employs a probabilistic or statistical based analysis in connection with the identification.

5. The system of claim 1, the data store is updated through at least one of a web-based search, an external process, and a manual user input.

6. The system of claim 1, the contacts in the data store correspond with at least one of a phone number and an e-mail address.

7. The system of claim 6, further comprising, the phone number is formatted in reverse order and the e-mail address as formatted in plain order before an “@” delimiter and reverse order after the “@” delimiter.

8. The system of claim 1, content within the data store is organized in alphabetical order by translated contact identifier.

9. The system of claim 1, further comprising a portable user interface that enables communication of data among users.

10. A computer-implemented method that facilitates matching a contact identifier with a contact, comprising the following computer-executable acts:
receiving a contact identifier;
translating the contact identifier;
identifying a contact in a data store corresponding to the translated contact identifier; and
returning the contact.

11. The method of claim 10, further comprising organizing an alphabetical index of translated contact identifiers and corresponding contacts in the data store.

12. The method of claim 11, further comprising:
locating a position of the translated contact identifier in the index;
determining whether the translated contact identifier exactly matches an entry in the index; and
determining whether the leading strings of the translated contact identifier and adjacent entries of contact identifiers match.

13. The method of claim 10, further comprising employing artificial intelligence to evaluate whether a proposed entry sufficiently matches the received translated contact identifier.

14. The method of claim 13, further comprising:
displaying at least one of a contact and artificial intelligence results by way of a portable user interface; and
employing a notification method based at least in part on a general preference and a specific preference.

15. The method of claim 10, further comprising:
reversing the digits of a phone number if the contact identifier is a phone number; and
reversing the characters after an “@” delimiter if the contact identifier is an e-mail address.

16. The method of claim 10, further comprising updating the data store through at least one of a web-based search and a manual user input.

17. A computer-implemented system that facilitates matching a contact identifier with a contact, comprising:
computer-implemented means for receiving a contact identifier;
computer-implemented means for translating the contact identifier;
computer-implemented means for identifying a contact in a data store corresponding to the translated contact identifier; and
computer-implemented means for returning the contact.

18. The system of claim 17, further comprising at least one of:
means for reversing the digits of a phone number if the contact identifier is a phone number;
means for reversing the characters after an “@” delimiter if the contact identifier is an e-mail address;
means for alphabetizing the translated contact identifiers in an index for the data store; and
means for updating the data store through at least one of an Internet search, a database search, and a manual user input.

19. The system of claim 17, further comprising means for processing possible contact matches with artificial intelligence.

20. The system of claim 19, further comprising:
means for displaying at least one of the contact match and artificial intelligence results; and
means for facilitating notification of the contact match based at least in part on a general preference and a specific preference.
